(19) United States
(12) Patent Application Publication
(10) Pub. No.: US 2015/0136664 A1
(43) Pub. Date: May 21, 2015

(54) CONTROLLING FROTH FLOTATION

(71) Applicant: TECHNOLOGICAL RESOURCES PTY. LIMITED, Brisbane, Queensland (AU)

(72) Inventors: Damien Harding, Clifton Hill (AU); Christopher Smith, South Jordan, UT (US)

(21) Appl. No.: 14/398,660

(22) PCT Filed: May 14, 2013
(86) PCT No.: PCT/AU2013/000495

§ 371 Date: Nov. 3, 2014

Related U.S. Application Data
(60) Provisional application No. 61/646,444, filed on May 14, 2012.

(51) Int. Cl. B03D 1/02; B03D 1/14

(52) U.S. Cl. CPC B03D 1/028; B03D 1/14
USPC 209/154

(57) ABSTRACT

A method of controlling a froth flotation cell in a froth flotation circuit for separating substances is disclosed. The method includes controlling flotation gas flow rate to the cell based on changes in cell conditions to maintain the operation of the cell at a peak froth stability of the cell or closer to the peak froth stability of the cell than if the flotation gas flow rate was not changed.

### TECHNICAL FIELD

The present invention relates to a method of controlling one or more than one flotation cell for separating substances in a feed material in a froth flotation circuit.

The present invention relates particularly, although by no means exclusively, to a method of controlling one or more than one flotation cell in a froth flotation circuit for separating substances, for example minerals containing valuable material such as valuable metals such as nickel and copper, from a feed material in the form of an ore that contains the minerals and other material (hereinafter referred to as “gangue”).

### BACKGROUND TO THE INVENTION

The following description of the invention focuses on a froth flotation method for separating particles of valuable minerals from particles of gangue in a feed material in the form of mined ores, but the invention is not confined to this application.

Froth flotation is a process for separating valuable minerals from gangue by taking advantage of hydrophobicity differences between valuable minerals and waste gangue in a feed material. The purpose of froth flotation is to produce a concentrate that has a higher grade, i.e. a higher product grade, of a valuable material (such as copper) than the grade of the valuable material in the feed material. Performance is normally controlled through the addition of surfactants and wetting agents to an aqueous slurry of particles of the minerals and gangue contained in a flotation cell. These chemicals condition the particles and stabilise the froth phase. For each system (ore type, size distribution, water, gas etc), there is an optimum reagent type and dosage level. Once the surface of the solid phases has been conditioned they are then selectively separated with a froth that is created by supplying a flotation gas, such as air, to the process. A concentrate of the minerals is produced from the froth. Like the chemical additives, the separation gas used to generate the froth is a process reagent with an optimum dosage level. The optimum dose of gas is a complex function of many system and equipment factors but for a given flotation cell can be determined empirically by maximising the gas recovery point for the cell.

The performance quality of a flotation process can be measured with respect to two characteristics of a concentrate that is extracted from a flotation cell—namely product grade and product recovery. Product grade indicates the fraction of a valuable material in the concentrate as compared to the remainder of the material in the concentrate. Product recovery indicates the fraction of the valuable material in the concentrate as compared to the total amount of the valuable material in the original feed material that was supplied to the flotation cell.

A key aim of an industrial flotation process is to control operating conditions in order to achieve an optimal balance between grade and recovery, with an ideal flotation process producing high recovery of high grade concentrate.

International publication WO 2009/044149 in the name of Imperial Innovations Limited relates to an invention of a method of controlling operation of a froth flotation cell that forms part of a froth flotation circuit. The method is based on controlling flotation gas flow rate into a cell so that the cell operates at maximum gas recovery for the cell.

The maximum gas recovery for a cell is described as the “peak gas recovery” and the gas flow rate at the peak gas recovery is described as the “peak gas rate”. In a situation in which the flotation gas is air, the maximum gas recovery is described as the “peak air recovery” and the air flow rate at the peak air recovery is described as the “peak air rate”.

The International publication describes that there is a correlation between operating a flotation cell to maximise gas recovery and maximising the combination of concentrate grade and concentrate recovery. In particular, the International publication describes that maximum gas recovery, i.e. peak gas recovery, coincides with optimum metallurgical performance, where metallurgical performance includes concentrate grade and concentrate recovery.

The applicant has considered how to control a flotation cell and a froth flotation circuit that comprises a plurality of flotation cells to maximise gas recovery and, more particularly peak recovery in situations where the flotation gas is air.

### SUMMARY OF THE INVENTION

The present invention is based on a realisation that it is not a straightforward exercise to continuously control the operation of such cells to maximise peak gas recovery. For example, variations in feed rate, froth level, solids composition, pulp pH, and chemical dosage rates can have a significant impact on the stability of cells.

The present invention is also based on a realisation that peak gas recovery for a cell coincides with a maximum froth stability (i.e. a peak froth stability) for the cell and that the peak froth stability is what drives the peak gas recovery.

The term “froth stability” is understood herein to mean the ability of bubbles in a froth to resist coalescence and bursting.

In broad terms, the present invention is a method of controlling a froth flotation cell in a froth flotation circuit for separating substances that includes controlling flotation gas flow rate to the cell based on changes in cell conditions to maintain the operation of the cell at a peak froth stability of the cell or closer to the peak froth stability of the cell than if the flotation gas flow rate was not changed.

According to the present invention there is provided a method of controlling a froth flotation cell in a froth flotation circuit for separating substances, the method including monitoring conditions of the cell and changing the flotation gas flow rate to the cell if there is a change in cell conditions in order to maintain the operation of the cell at a peak froth stability or closer to the peak froth stability of the cell than if the flotation gas flow rate was not changed.

The change in cell conditions may be a change in one selected cell condition or changes in a number of selected cell conditions. The change in cell conditions may be any change in conditions that is regarded as being a significant change from the viewpoint of operating the cell at the peak froth stability of the cell or closer to the peak froth stability of the cell. By way of example, the change in cell condition or conditions may be a predetermined change based on operational knowledge of the cell.

The cell condition or conditions may be monitored directly or indirectly. One example of indirect monitoring of a cell condition is monitoring data that is derived from or based on a cell condition. One specific example is set point data for a cell condition. Set point data is understood herein to mean data indicating a set point for a monitored cell condition wherein the cell condition is maintained at or close to the set point, usually by an automated control loop.

The term “gas flow rate” to the cell as used herein is understood to be interchangeable with the term “superficial gas velocity” within the cell.

The method may include changing the gas flow rate to the cell by a predetermined amount if there is a predetermined change in cell conditions.

The conditions may include any one or more of the following inputs to the cell: feed rate, solids concentration in the feed, particle size distribution of solids in the feed, pH of the feed, gas flow rate, chemical dosage rate, feed grade, feed type, and froth depth.

The conditions may include any one or more of the following outputs of the cell: concentrate grade, concentrate recovery, gas recovery, and gas hold-up.

The term “gas hold-up” in understood herein to mean the volume of gas in a pulp zone of a flotation cell. The volume of gas reduces the pulp volume and therefore decreases the residence time available for flotation. The gas hold-up depends on the amount of gas added to the flotation cell and is a strong function of pulp viscosity.

The method may include automatically changing the gas flow rate to the cell if there is a change in cell conditions.

The method may include determining the change in the gas flow rate for the cell required in any given situation by reference to data obtained by calibrating the cell. The data may relate to a range of different actual operating conditions for the cell and the gas flow rates required to operate at the peak froth stability of the cell across the range of actual operating conditions. The data may be part of a control system for the cell.

The method may include “matching” the shape of a froth stability/gas recovery versus gas flow rate curve generated from calibration data with cell conditions. As a set of cell conditions is likely to yield a uniquely shaped curve, curves generated from calibration data from a cell can be used to locate the peak gas rate for similar cell conditions. Two sets of cell conditions may yield the same peak gas rate, but different shaped froth stability/gas recovery curves or two sets of cell conditions may yield a different peak gas rate and different shaped curves. Two sets of cell conditions may also appear to yield the same shaped curve, but actually yield different peak gas rates.

The method may include carrying out a control routine to check the froth stability of the cell. The control routine may be carried out after changing the gas flow rate to the cell in response to monitored changes to cell conditions. The control routine may be carried out in parallel to monitoring the cell conditions and changing the gas flow rate to the cell in response to monitored changes to cell conditions.

The control routine may be as described in International application PCT/AU2011/001480 in the name of the applicant and may include changing the gas flow rate to the cell in a series of steps and assessing the froth stability at each gas flow rate and continuing the step changes in the gas flow rate until the froth stability is the peak froth stability or is within a predetermined range of the peak froth stability of the cell. The disclosure in the International application is incorporated herein by cross reference.

The method may include carrying out a control routine comprising changing the gas flow rate to the cell in a series of steps and assessing the froth stability at each gas flow rate and continuing the step changes in the gas flow rate so that the cell approaches the peak froth stability of the cell, wherein the cell conditions are monitored in-between making the steps and the flotation gas flow rate to the cell is changed if there is a change in cell conditions.

According to the present invention there is also provided a method of controlling a froth flotation circuit including a plurality of froth flotation cells for separating substances, the method including monitoring conditions in at least one cell and changing the flotation gas flow rate to the cell if there is a change in cell conditions in order to maintain the operation of the cell at a peak froth stability of the cell or closer to the peak froth stability of the cell than if the flotation gas flow rate was not changed.

The method may include changing the gas flow rate to the cell by a predetermined amount if there is a predetermined change in cell conditions.

The method may include automatically changing the gas flow rate to the cell if there is a predetermined change in cell conditions.

The method may include determining the change in the gas flow rate for the cell required in any given situation by reference to data obtained by calibrating the cell. The data may relate to a range of different actual operating conditions for the cell and the gas flow rates required to operate at the peak froth stability of the cell across the range of actual operating conditions. The data may be part of a control system for the cell. The data may be part of a control system for the circuit.

The method may include “matching” the shape of a froth stability/gas recovery versus gas flow rate curve generated from calibration data with cell conditions. As a set of cell conditions is likely to yield a uniquely shaped curve, curves generated from calibration data from a cell can be used to locate the peak gas rate for similar cell conditions. Two sets of cell conditions may yield the same peak gas rate, but different shaped froth stability/gas recovery curves or two sets of cell conditions may yield a different peak gas rate and different shaped curves. Two sets of cell conditions may also appear to yield the same shaped curve, but actually yield different peak gas rates.

The method may include carrying out a control routine to check the froth stability of the cell.

The method may include carrying out a control routine to check the froth stability after making the change to the gas flow rate to the cell, the control routine comprising changing the gas flow rate to the cell in a series of steps and assessing the froth stability at each gas flow rate and continuing the step changes in the gas flow rate until the froth stability is the peak froth stability or closer to the peak froth stability of the cell than if the flotation gas flow rate was not changed.

The control routine may be as described in International application PCT/AU2011/001480 in the name of the applicant.

The method may include carrying out a control routine including changing the gas flow rate to the cell in a series of steps and assessing the froth stability at each gas flow rate and continuing the step changes in the gas flow rate so that the cell approaches the peak froth stability of the cell, wherein the cell conditions are monitored in-between making the steps and the flotation gas flow rate to the cell is changed if there is a change in cell conditions.

The method may include periodically carrying out the control routine in a selected cell in the froth flotation circuit to maximise froth stability of the selected cell. Thereafter, the method may include periodically carrying out the control routine in other cells in the froth flotation circuit.

The method may include continuously carrying out the control routine in a selected cell in the froth flotation circuit to maximise froth stability of the selected cell.

The method may include periodically carrying out the control routine in all of the cells or a selection of cells or the “rougher” bank of cells in the froth flotation circuit.

The method may include continuously carrying out the control routine in all of the cells or a selection of cells or the “rougher” bank of cells in the froth flotation circuit.

### BRIEF DESCRIPTION OF THE DRAWINGS

The present invention is described further by way of example only with reference to the accompanying drawings, of which:

FIG. 1 is a schematic diagram of a basic froth flotation cell;

FIG. 2 is a schematic diagram of a basic froth flotation circuit which comprises a plurality of cells arranged in banks of cells;

FIG. 3 is a graph of metal recovery in a concentrate versus metal grade in the concentrate which illustrates the relationship between these parameters in a typical flotation cell;

FIG. 4 is a graph of air recovery versus air flow rate of a flotation cell of the type shown in FIG. 1;

FIG. 5 is a flow diagram of a basic control system for the flotation cell shown in FIG. 1;

FIG. 6 is a graph of gas recovery versus gas flow rate of a flotation cell of the type shown in the FIG. 1 circuit under 3 different sets of operating conditions;

FIG. 7 is FIG. 4 of International application PCT/AU2011/001480 and is a schematic diagram of an example of one embodiment of a control routine in a froth flotation cell, for example of the type shown in FIG. 1;

FIG. 8 is a flow diagram of another embodiment of a basic control system for the flotation cell shown in FIG. 1;

FIG. 9 is a schematic graphical user interface of the control system of FIG. 5 or FIG. 8;

FIG. 10 is a flow diagram of the basic control system of FIG. 5 or FIG. 8 including a Peak Air Recovery finder routine; and

FIG. 11 is a flow diagram of the basic control system of FIG. 5 or FIG. 8 incorporating a Peak Air Recovery finder routine.

### DESCRIPTION OF EMBODIMENT(S)

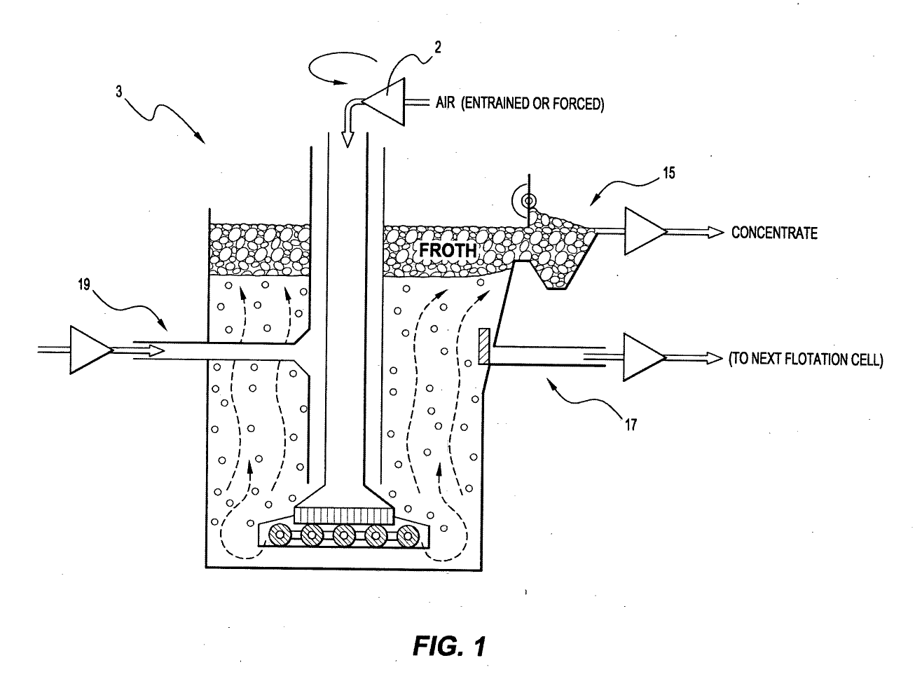

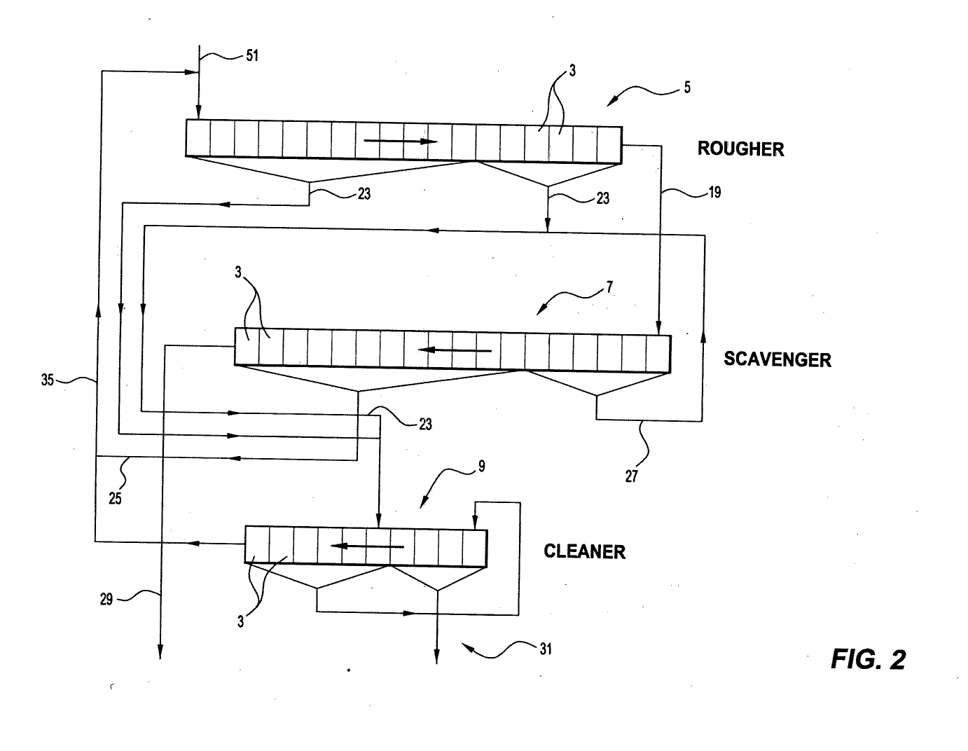

The basic froth flotation cell and the basic froth flotation circuit shown in FIGS. 1 and 2, respectively, are conventional.

The circuit shown in FIG. 2 comprises a plurality of the cells 3 shown in FIG. 1 that are arranged in banks 5, 7, 9 of cells. The cells 3 in each bank are arranged in series. The cells 3 are conventional cells.

With reference to FIG. 1, each cell 3 includes (a) an inlet 13 for an aqueous slurry of particles of a feed material, (b) an outlet 15 for a froth that contains particles of a valuable material, typically a valuable metal (such as copper), and (c) an outlet 17 for tailings. It is noted that the present invention is not confined to slurries that are aqueous slurries.

The feed material to each cell 3 in the bank 5 of cells 3, which is commonly referred to as a “rougher” bank of cells, has a required particle size distribution and has been dosed appropriately with chemicals to facilitate flotation (such as chemicals that act as “collectors” and “conditioners”).

The feed material to the rougher bank 5 may be any suitable material. The following description focuses on a feed material in the form of an ore that contains valuable minerals. The valuable minerals are minerals that contain valuable material in the form of a valuable metal, such as copper. The feed material is obtained from a mined ore that has been crushed and then milled to a required particle size distribution.

The slurry of the feed material that is supplied to the cells 3 in the rougher bank 5 is processed in these cells 3 to produce froth and tailings outputs. The processing comprises introducing a suitable flotation gas, typically air, at a selected gas flow rate into a lower section of the cells 3 via an air control valve 2. Controlling the air control valve 2 controls the gas flow rate into the cell 3. The gas rises upwardly and suitably conditioned particles of the feed material attach to the gas bubbles. The gas bubbles form a froth.

The froth from the cells 3 in the rougher bank 5 is transferred via transfer lines 23 to a second bank 9 of cells 3, which is described as a “cleaner” bank of cells. The froth is processed in these cells 3 in the cleaner bank 9 as described above in relation to the cells 3 in the rougher bank 5 to produce froth and tailings outputs.

The tailings from the rougher bank 5 are transferred via a transfer line 19 to a third bank 7 of cells, which is described as a “scavenger” bank of cells. The tailings are processed in these cells 3 in the scavenger bank 7 to produce froth and tailings outputs.

The froth from the scavenger bank 7 is transferred via lines 25 and 35 to the rougher bank 5 and via line 27 to the cleaner bank 9.

The froth from the cleaner bank 9 is transferred via a transfer line 31 to downstream operations (not shown) for processing to form a concentrate. The concentrate is transferred to a downstream processing operation to recover the valuable metal from the concentrate.

The tailings from the scavenger bank 7 are transferred via a line 29 to waste disposal not shown.

The tailings from the cleaner bank 9 are returned via a transfer line 35 to the rougher bank 5.

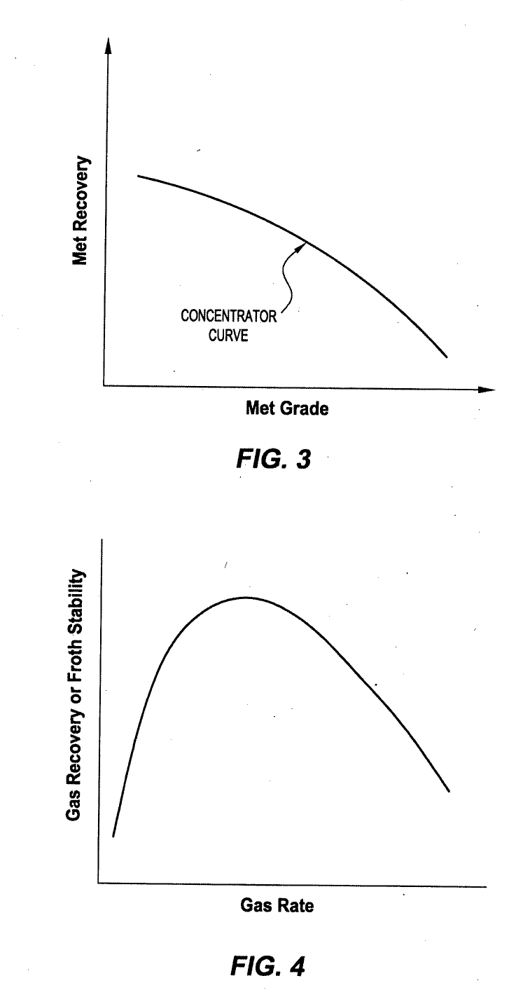

The graph of valuable metal recovery in a concentrate from a froth flotation circuit versus valuable metal grade in the concentrate in FIG. 3 illustrates the relationship between these parameters in a typical circuit. The Figure shows that in a typical froth flotation circuit for a valuable metal, recovery of the valuable metal in the concentrate decreases as the metal grade in the concentrate increases. Generally, the metal recovery can be increased by operating froth flotation cells at lower froth depths in the cells. Generally, operators want the highest possible grade concentrate and the highest possible recovery, where recovery is defined as the proportion of the valuable metal that is in the concentrate compared to the total amount of valuable metal in the feed material. In practice, in many situations, product grade in a concentrate in a plant is relatively fixed because of downstream processing constraints and it is desirable to be able to maximise the recovery for a given grade.

FIG. 4 shows that as the air flow rate of the cell increases the air recovery increases to a peak air recovery and then decreases.

As is described above, the applicant has considered how to control a flotation cell and a froth flotation circuit that comprises a plurality of flotation cells to maximise gas recovery and, more particularly peak gas recovery in situations where the flotation gas is air, and the applicant has realised that such control is not a straightforward exercise.

As is described above, in general terms, the present invention is a method of controlling at least one froth flotation cell in a froth flotation circuit that is based on a feed forward control methodology whereby the flotation gas (such as air) flow rate for a cell is adjusted, for example automatically, and for example by a predetermined amount, if there is a change, for example a predetermined change, in a selected cell operating condition or conditions (which may be cell input and cell output conditions). Basically, the purpose of the flotation gas flow rate adjustment is to operate the cell at the peak gas rate and thereby maximise gas recovery and cell performance. The conditions may include any one or more of the following inputs to the cell: feed rate, solids concentration in the feed, particle size distribution of solids in the feed, pH of the feed, gas flow rate, chemical dosage rate, feed grade, feed type, and froth depth. The conditions may include any one or more of the following outputs of the cell: concentrate grade, concentrate recovery, gas recovery, and gas hold-up. The change in cell conditions may be a predetermined change in one selected cell condition or predetermined changes in a number of selected cell conditions.

The required change, such as the required predetermined change, in the gas flow rate is based on information obtained by calibrating the cell and compiling data on flotation gas flow rate that is required for each of a number of sets of cell operating conditions to obtain a peak froth stability (which the applicant has found drives a peak gas recovery) for each cell condition. This data is part of a control system for a cell and for a froth flotation circuit comprising a plurality of such cells.

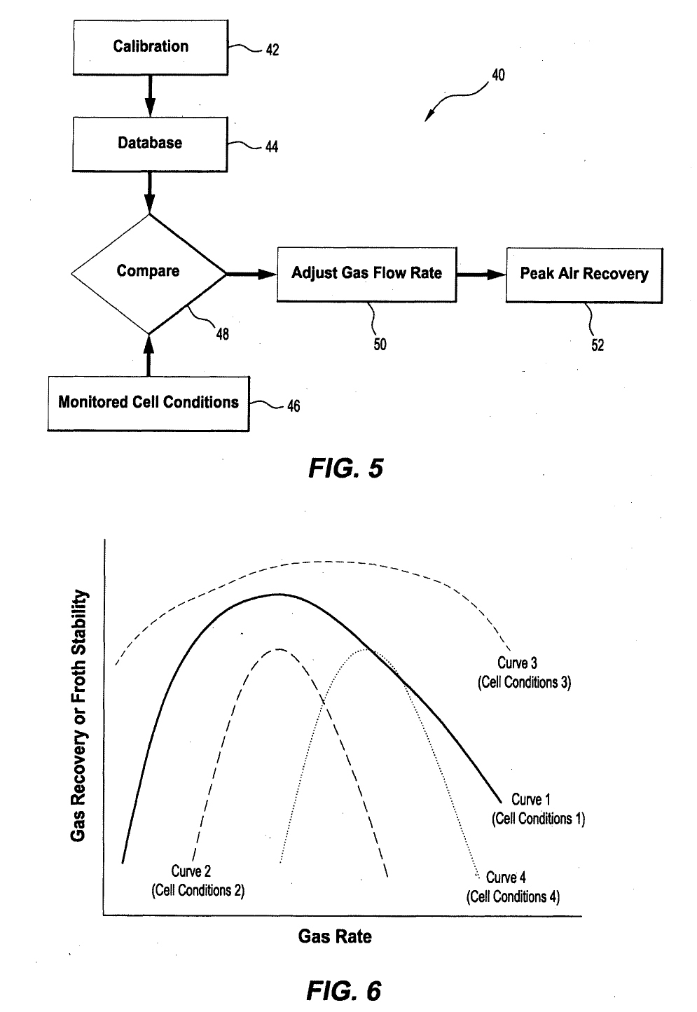

FIG. 5 shows a flow diagram of a basic control system 40 for the cells including feed forward control steps. The cell is calibrated 42, which may include learning from different cell operating conditions, to obtain a database 44 of different cell conditions and different gas flow rates for the different cell conditions to realise peak air recovery and/or froth stability. During control of the cell, the monitored cell conditions 46 are compared 48 against the database 44 of cell conditions. The control system is operable in response to a predetermined change in a selected monitored cell operating condition to adjust the gas flow rate in step 50 to match the gas flow rate provided in the database 44 to achieve peak air recovery 52 for a given set of cell conditions.

In other words, this embodiment of the invention utilizes data, held for example in a system memory, from previous operations of a cell, to adjust, for example automatically, the gas flow rate for a given set of cell conditions. This reduces the time taken to set the peak gas rate for a cell and minimizes downstream disturbances caused by continued gas rate variation as the system searches to set the peak gas rate in the cell.

The method may include “matching” the shape of a froth stability/gas recovery curve versus flotation gas flow rate generated from calibration data with cell conditions. This is illustrated in FIG. 6, which is a graph of froth stability/gas recovery versus flotation gas flow rate of a flotation cell 3 of the type shown in the FIG. 1 circuit under 4 different sets of operating conditions. As a set of cell conditions is likely to yield a uniquely shaped curve, curves generated from calibration data from a cell can be used to locate the peak gas rate for similar cell conditions. Two sets of cell conditions may yield the same peak gas rate, but different shaped froth stability/gas recovery curves (cf curves 1 and 2 on FIG. 6). Two sets of cell conditions may yield a different peak gas rate and different shaped curves (cf curves 1 or 2 with curve 3 on FIG. 6). Two sets of cell conditions may also appear to yield the same shaped curve, but actually yield different peak gas rates (cf curves 2 and 4 on FIG. 6).

In one embodiment of the control system, a Peak Air Recovery (PAR) finder control routine is run periodically to check whether the froth stability of the cell is at or close to the peak froth stability for that cell. The control system wherein the PAR finder control routine is run periodically is described in more detail with reference to FIG. 10.

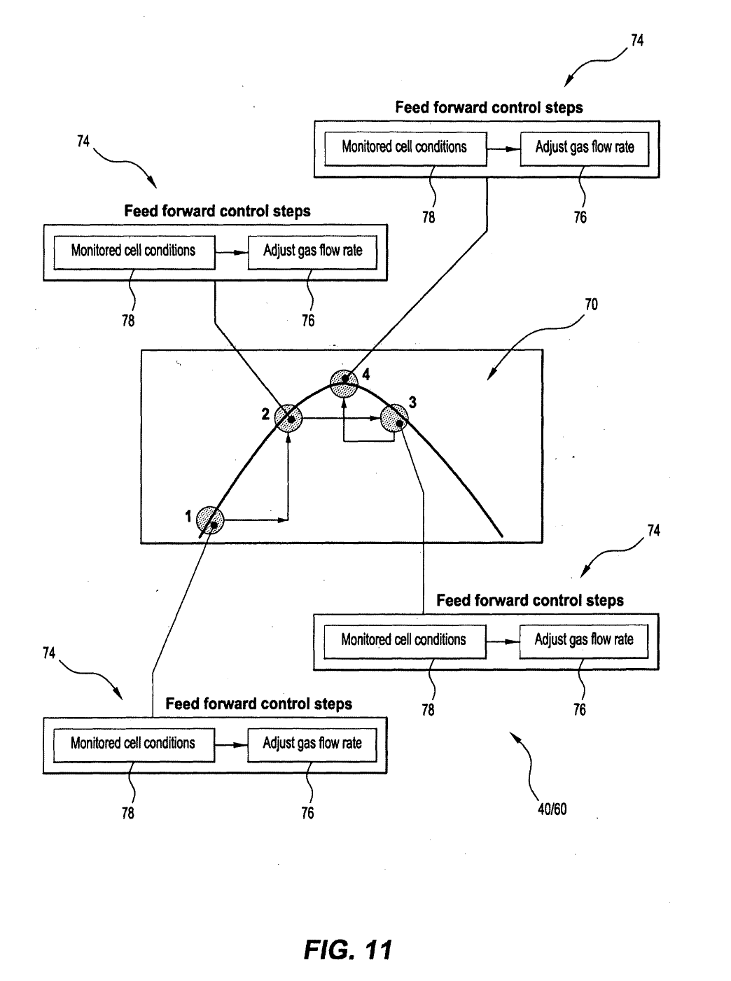

In another embodiment of the control system, the Peak Air Recovery finder control routine runs continuously with periodic steps to check whether the froth stability of the cell is at or close to the peak froth stability for that cell. The control system wherein the PAR finder control routine is run continuously is described in more detail with reference to FIG. 11.

The PAR finder control routine forms part of the control system.

One PAR finder control routine option, as described in International application PCT/AU2011/001480, comprises changing the gas flow rate to the cell in a series of steps and assessing the froth stability at each gas flow rate and continuing the step changes in the gas flow rate until the froth stability is a peak froth stability or is close to the peak froth stability, such as within a predetermined range of the peak froth stability of the cell.

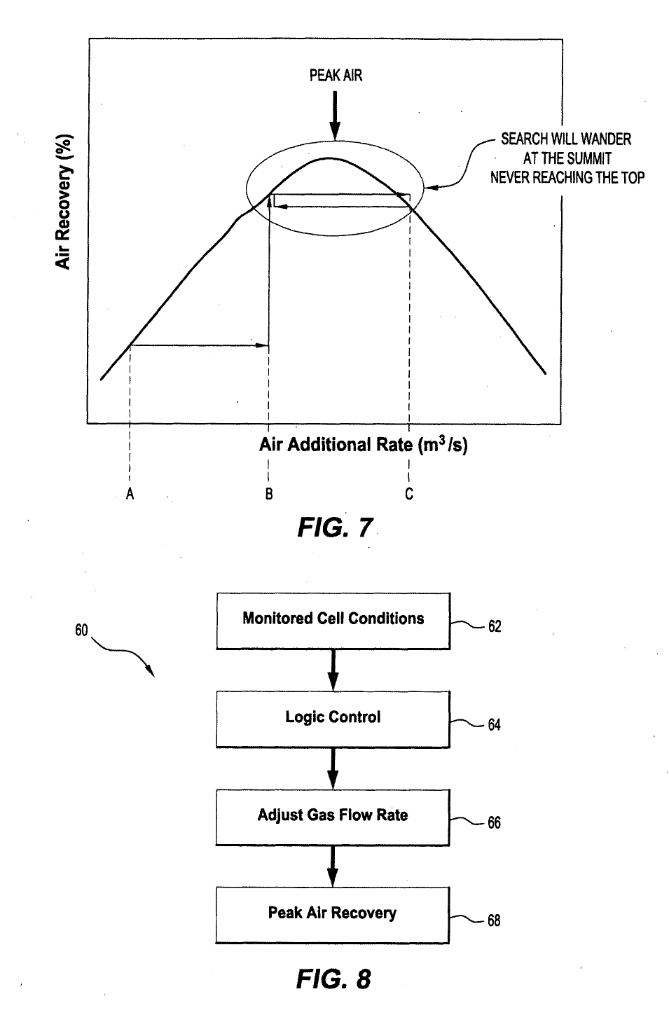

The schematic diagram of FIG. 7 is FIG. 4 of International application PCT/AU2011/001480 and is an example of one embodiment of the control routine in a froth flotation cell, for example of the type shown in FIG. 1, in which the flotation gas is air.

In this embodiment of the PAR finder control routine, froth stability is assessed by assessing the air recovery of the cell. The present invention is not limited to assessing froth stability via air recovery and extends to any options for assessing froth stability. Other options include, by way of example, assessing bubble collapse rate in froth in the cell and bubble coalescence rate in froth in the cell. Yet another example is using a forth stability column as described in International application PCT/AU2004/000311.

The example of the control routine shown in FIG. 7 comprises making a series of step changes in the air flow rate to the cell over a selected time period and assessing air recovery at each step change and repeating these steps until the air recovery at an air flow rate of a step is the peak air recovery or close to the peak air recovery, with the selection of each air flow rate being based on whether previous air flow rates resulted in an increase or a decrease in the air recovery. More particularly, the control routine comprises the following steps:
(a) measuring the air recovery (or another parameter that is indicative of froth stability) at a current air flow rate “A”,
(b) increasing the air rate to the cell to air flow rate “B”,
(c) measuring the air recovery at air flow rate “B” and assessing whether the air recovery has increased or decreased at this air flow rate,
(d) given that there was an increase in air recovery at air flow rate “B” compared to air flow rate “A”, increasing the air flow rate to air rate “C”,
(e) measuring the air recovery at air flow rate “C” and assessing whether the air recovery has increased or decreased at this air flow rate,
(f) given that there was no increase in air recovery at air flow rate “C” compared to air flow rate “B”, reducing the air flow rate to air rate “B”,
(g) measuring the air recovery at air flow rate “B” and assessing whether the air recovery has increased or decreased at this air flow rate, and
(h) repeating the steps until there is substantially no change in the air recovery with successive changes in air flow rate, which indicates that the air recovery is at or close to the peak air recovery.

The amount of the increase or decrease of the air flow rate to the cell may be the same or may vary in successive steps of the control routine. For example, the amount of the increase or decrease may be reduced as the difference between the air recoveries in successive steps decreases.

International application PCT/AU2011/001480 describes other embodiments of the control routine in a froth flotation cell. One of these other embodiments is described in relation to FIGS. 6-8 of the International application and assesses different gradients between sets of points on an air flow (addition) rate versus air recovery graph. The method is based on the understanding that the gradient of a tangent at the peak air recovery will be approximately zero.

Having at least two gradients on the graph provides information to enable an estimate of the air flow rate at peak air recovery.

In general terms, the steps of the method may be described by the following search algorithm:
(a) measure the air recovery at a current air flow;
(b) make either a ± step in the air flow rate,
(c) measure the air recovery at the new air flow rate;
(d) calculate the gradient in the change in air recovery over the change in air rate between the two points;
(e) make another + or − step in the air flow rate;
(f) measure the air recovery at the new air flow rate;
(g) calculate the gradient in the change in air recovery over the change in air rate between the two points;
(h) use the two gradients A, B to estimate the air flow rate at peak air recovery;
(i) optionally generate more points at air flow rates closer to the estimated air flow rate for peak air recovery, thereby to generate new gradients between sets of points with the gradients converging to zero gradient.

Many more points may be taken to increase the accuracy of the prediction of the air flow rate at peak air recovery. In particular the gradients between previous sets of points may be used to predict the necessary change in air flow rate to establish a new point on the graph which forms part of a set of points having a gradient between them closer to zero.

FIG. 8 shows a flow diagram of another embodiment, although not the only other possible embodiment, of a basic control system 60 for the cells including feed forward control steps. The control system 60 includes a logic controller 64 which includes logic control rules for adjusting the gas flow rate 66 depending on changes to the monitored cell conditions 62. The logic control rules may be algorithms. In its most basic form the logic control rules are operable to change the gas flow rate by an amount proportional to the change in a monitored cell condition. For example, if the monitored condition of pulp level changes by +0.5 inch the air flow rate is changed by k×0.5 cubic feet per minute. The value of k is set by empirical testing of the effect of change of cell conditions on the peak air recovery/froth stability and includes a user adjustable gain for fine tuning of the system. The direction of change (i.e. if k is positive or negative depending on whether the relationship is direct or inverse) is also stored in the logic controller 64. The logic controller 64 keeps the air flow rate relatively closer to the air flow rate for peak air recovery than if the air flow rate was not changed by the logic controller. This has the benefit of maintaining the cell relatively closer to peak air recovery in between the periodic PAR finder control routines as described with reference to FIG. 10, or in between the PAR finder control routine steps as described with reference to FIG. 11.

The gas flow rate is adjusted by adjusting the air control valve 2 (see FIG. 1). It will be appreciated that any reference to adjusting the gas flow rate includes reference to adjusting the position of the air control valve 2. As such, the control systems described with reference to FIGS. 5 and 8 control the position of the air control valve 2 to thereby change the air flow rate. Calibration of the cells includes calibration of the positions of the air control valve 2, such that any change in cell conditions effect a predetermined change in air control valve 2 position.

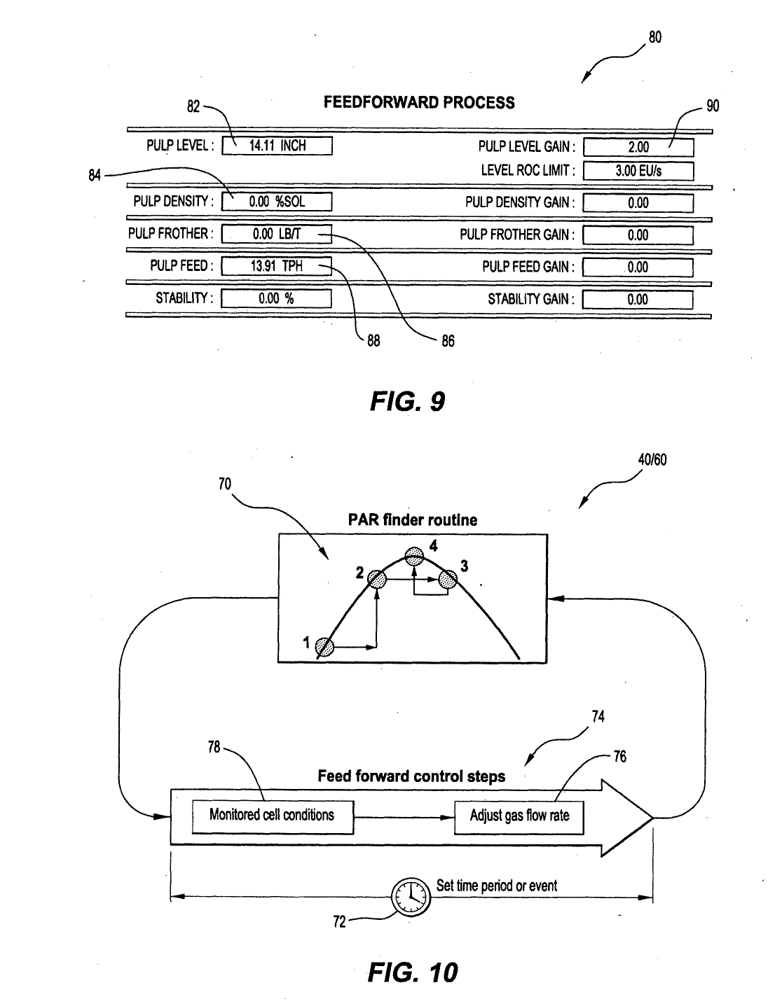

The control system 60 is configured so that the air control valve 2 positions are adjusted depending on changes to the monitored cell conditions 62. FIG. 9 shows example monitored cell conditions displayed in a graphical user interface 80 of the control system 60. The cell conditions include:
pulp level 82, which is a measure of the depth of the froth measured from the top of the lip measured in inches;
pulp density 84, which is a measure of the solids concentration in the pulp measured in % solids;
pulp frother 86, which is a measure of the amount of frother reagent per ton is added to the pulp;
pulp feed 88, which is a measure of the feed rate of pulp to the cell, measured in tons per hour.

The control system 60 is configured so that any changes in the monitored cell conditions 82-88 will result in a change in the air control valve 2 positions to change air flow rate into the cell. The size of the change in air control valve 2 positions relative to a change in a monitored cell condition is set in the logic rules of the logic controller 64. The size of the change is adjustable by changing the gain value 90 in the user interface. As can be seen the gains 90 in interface 80 are set so that pulp level (gain 2.0) is the only monitored condition to have an effect on changing air valve position.

The data of the monitored cell conditions 82-88 may be real time variable data that changes as the conditions change in real time or may be set-point data. Set point data is data indicating the set point for the monitored cell condition wherein the cell condition is maintained at or close to the set point, usually by an automated control loop. In certain instances the set point data may be preferred for being more stable than the real time variable data, but remains an indication of the monitored cell condition.

The feed forward control steps for pulp level 82 is an example where the logic control 64 decreases the air rate for increases in pulp level to maintain the cell close to Peak Air Recovery. Conversely for a monitored decrease in pulp level the control system 60 increases the air rate.

Referring to FIG. 10, the control system 40, 60 runs the PAR finder routine 70 as described above periodically, for example every 3 hours as indicated by timer 72. In-between the times that the PAR finder routine is run, the feed forward control steps 74 are active in monitoring the cell conditions 78 and making corresponding adjustments 76 to the gas flow rate in response to changes in the monitored cell conditions. The PAR finder routine 70 may also be selectively run when a predefined event occurs, for example when a monitored control condition reaches a limit or has a significant change. The PAR finder routine may be set to run for a predetermined number of steps, for a predetermined time or once a specified objective function is met.

Referring to FIG. 11, the control system 40, 60 illustrated in this Figure runs the PAR finder routine 70 continuously in a manner wherein there are set time periods between which air flow rate adjustment steps are taken. Each of the numerals 1, 2, 3 and 4 in FIG. 11 shows a different air flow rate where the PAR finder routine pauses for the set time periods to calculate froth stability at the given air flow rate. The set time periods between making air flow rate changes may generally be a pause of 5 minutes or 10 minutes. During the set time period pauses between the air flow rate adjustment steps the feed forward control steps 74 are active to monitor cell conditions 78 and making corresponding adjustments 76 to the gas flow rate in response to changes in the monitored cell conditions.

The advantages of the present invention include the following advantages.
1. Reduce the time to set the peak gas rate of a cell after a change in cell conditions.
2. Limit the time a cell is away from the peak gas rate during control system operation searching for the peak gas rate.
3. Maximize the time a cell is operating at peak gas rate and providing metallurgical benefit.
4. Reduce the likelihood of downstream disturbances due to continuous gas rate fluctuation away from the peak gas rate.

The above description of the invention with reference to the Figures focuses on individual cells in a froth flotation circuit comprising a plurality of such cells. The present invention also extends to froth flotation circuits per se. It can be appreciated that, if changes to the air flow rate for one cell are necessary so that the cell operates at or close to the peak froth stability for that cell, it may also be the case that changes to the air flow rates for other cells in the circuit may be required so that these cells operate at the peak froth stability for each cell. As a consequence, it may be appropriate to carry out the method of the invention on a selection or all of the cells in a circuit.

Many modifications may be made to the embodiments of the present invention described above without departing from the spirit and scope of the invention.

By way of example, whilst FIGS. 1 and 2 illustrate a particular construction of a flotation cell and a particular flotation circuit, the present invention is not so limited and extends to any suitable construction of a flotation cell and any suitable flotation circuit.

1. A method of controlling a froth flotation cell in a froth flotation circuit for separating substances, the method including monitoring conditions of the cell and changing the flotation gas flow rate to the cell if there is a change in cell conditions in order to maintain the operation of the cell at a peak froth stability or closer to the peak froth stability of the cell than if the flotation gas flow rate was not changed.

2. The method defined in claim 1 includes changing the gas flow rate to the cell by a predetermined amount if there is a predetermined change in cell conditions.

3. The method defined in claim 1 includes automatically changing the gas flow rate to the cell if there is a predetermined change in cell conditions.

4. The method defined in claim 1 wherein the conditions are any one or more of the following inputs to the cell: feed rate, solids concentration in the feed, particle size distribution of solids in the feed, pH of the feed, gas flow rate, chemical dosage rate, feed grade, feed type, and froth depth.

5. The method defined in claim 1 wherein the conditions are any one or more of the following outputs of the cell: concentrate grade, concentrate recovery, gas recovery, and gas hold-up.

6. (canceled)

7. The method defined in claim 1 includes monitoring the cell condition indirectly by monitoring set point data for the cell condition.

8. The method defined in claim includes determining the change in the gas flow rate for the cell required in any given situation by reference to data obtained by calibrating the cell.

9. (canceled)

10. The method defined in claim 8 includes “matching” the shape of a froth stability/gas recovery versus gas flow rate curve generated from calibration data with cell conditions.

11. The method defined in claim 1 includes carrying out a control routine to check the froth stability of the cell after making the change to the gas flow rate to the cell, the control routine including changing the gas flow rate to the cell in a series of steps and assessing the froth stability at each gas flow rate and continuing the step changes in the gas flow rate until the froth stability is a peak froth stability or closer to the peak froth stability of the cell than if the gas flow rate was not changed.

12. The method defined in claim 1 includes carrying out a control routine to check the froth stability of the cell including changing the gas flow rate to the cell in a series of steps and assessing the froth stability at each gas flow rate and continuing the step changes in the gas flow rate so that the cell approaches the peak froth stability of the cell, wherein the cell conditions are monitored in-between making the steps and the flotation gas flow rate to the cell is changed if there is a change in cell conditions.

13. A method of controlling a froth flotation circuit including a plurality of froth flotation cells for separating substances, the method including monitoring conditions of at least one cell and changing the flotation gas flow rate to the cell if there is a change in cell conditions in order to maintain the operation of the cell at a peak froth stability or closer to the peak froth stability of the cell than if the flotation gas flow rate was not changed.

14. The method defined in claim 13 includes changing the gas flow rate to the cell by a predetermined amount if there is a predetermined change in cell conditions.

15. The method defined in claim 13 includes automatically changing the gas flow rate to the cell if there is a predetermined change in cell conditions.

16. The method defined in claim 13 wherein the conditions are any one or more of the following inputs to the cell: feed rate, solids concentration in the feed, particle size distribution of solids in the feed, pH of the feed, gas flow rate, chemical dosage rate, feed grade, feed type, and froth depth.

17. The method defined in claim 13 wherein the conditions are any one or more of the following outputs of the cell: concentrate grade, concentrate recovery, gas recovery, and gas hold-up.

18. (canceled)

19. The method defined in claim 13 includes monitoring the cell condition indirectly by monitoring set point data for the cell condition.

20. The method defined in claim 13 includes determining the change in the gas flow rate for the cell required in any given situation by reference to data obtained by calibrating the cell.

21. (canceled)

22. The method defined in claim 20 includes “matching” the shape of a froth stability/gas recovery versus gas flow rate curve generated from calibration data with cell conditions.

23. The method defined in claim 13 includes carrying out a control routine to check the froth stability after making the change to the gas flow rate to the cell, the control routine including changing the gas flow rate to the cell in a series of steps and assessing the froth stability at each gas flow rate and continuing the step changes in the gas flow rate until the froth stability is a peak froth stability or closer to the peak froth stability of the cell than if the gas flow rate was not changed.

24. The method defined in claim 13 includes carrying out a control routine to check the froth stability of the cell including changing the gas flow rate to the cell in a series of steps and assessing the froth stability at each gas flow rate and continuing the step changes in the gas flow rate so that the cell approaches the peak froth stability of the cell, wherein the cell conditions are monitored in-between making the steps and the flotation gas flow rate to the cell is changed if there is a change in cell conditions.
